(19) United States
(12) Patent Application Publication
(10) Pub. No.: US 2011/0094114 A1
(43) Pub. Date: Apr. 28, 2011

(54) Razor handle extension shaving assembly

(76) Inventor: Colleen Payne-Baggetta, Columbia, SC (US)

(21) Appl. No.: 12/589,370

(22) Filed: Oct. 22, 2009

(51) Int. Cl. B26B 21/52

(52) U.S. Cl. 30/526

(57) ABSTRACT

Razor handle extension shaving assembly for extending the reach of a razor shaving apparatus via handle means. There is disclosed a razor handle extension shaving assembly that is easy to use and manufacture having a simplistic, yet efficient design for a handle extension assembly having a substantially unitary structure without relative moving parts. The assembly is comprised of lightweight materials and containing an array of fluid flow apertures for facilitating use in wet and/or slippery conditions. A unique razor device retention mechanism consisting of a frictional grip means and razor receiving means operatively coupled to one another are distinctive features and said means is adapted to receive a variety of differently sized razor devices. Another feature of the assembly lies in a unique handle structure having an angled portion along a reduced diameter middle portion.

### FIELD OF INVENTION

The present invention relates to a razor shaving apparatus. In particular, the present invention relates to extending the reach of a razor shaving apparatus via handle means.

### BACKGROUND

One disadvantage to using conventional razor devices is the limited length of the razor handle. Customary razor devices only provide a reach range being substantially equal to that of a user's hand holding the razor to substantially adjacent the area being shaved by the razor. The limited length of conventional razor handles does not extend the reach of the individual much further beyond the reach of their hands. This often presents a problem in various situations such as to women in pregnancy, or persons with physical impairments who, because of their physical condition, find it difficult to bend and/or reach the particular target areas being shaved. The prior art addresses this problem in several different ways.

The U.S. patent to Doyle, U.S. Pat. No. 6,189,222 issued Feb. 20, 2001, for an Articulated Razor Handle Extension shows a means for extending the handle of a razor device using a handle having articulated arm joints. The U.S. patent to Olson, U.S. Pat. No. 5,600,887, issued Feb. 11, 1997, for a Flexible Easy-Rinsing Razor teaches of an extendable razor handle having an elongating telescoping handle for facilitating ease of rinsing and cleaning. The U.S. patent to Zowaski, U.S. Pat. No. 626,688, issued Jul. 31, 2001, for a Reaching Razor, illustrates a razor with a flexible extended handle having a series of segmented links (see FIG. 2) providing the structure for the elongated handle.

In the U.S. Published Patent Publication No. 2003/0177649 to Zeiter, issued Sep. 25, 2003, there is disclosed an Extension Shaver and Method. This published patent application shows a unique extendable razor device having a handle that has joints for changing the arc (and thus the angle) of the razor handle with attachment means of the handle to the razor comprising a nuts and bolts type of connection. The U.S. Pat. No. 5,167,069 to Quinn, entitled Razor Reach, issued Dec. 1, 1992, illustrates a razor shaving apparatus having a telescoping, extendable handle with the razor being attached by way of a pivot. The U.S. patent to Morgan, U.S. Pat. No. 5,911,480 issued on Jun. 15, 1999 entitled Razor Having Extendable Handle with Adjustable Positions, shows a razor having an extendable, telescoping handle with a telescoping segment which is slidingly movable and frictionally securable. The U.S. Pat. No. 4,905,372, entitled Razor Handle Extension to Willis illustrates a razor extending device having a receiving means at the distal end for receiving and retaining a razor. For example, in FIG. 3, the friction ring structure for holding a razor in place is shown.

There are various design patents that show designs addressing the problem of extending the reach of razor and/or shaving devices. The U.S. Design Pat. No. D560032 to Lopez, issued Jan. 15, 2008, for a Razor Handle Extension shows a razor extending device which also holds and receives a razor at an open end. The U.S. Design Pat. No. D472673 to Corvetta, issued Apr. 1, 2003, for a Wand for Razor Handle Extension, shows a design of a razor extending device which also holds and receives a razor at an open end. U.S. Design Pat. No. D5000172 for an Extended Reach Razor to Fields patented Dec. 21, 2004, shows a razor having an elongated handle portion.

What is needed to overcome the problem of lack of reach with regard to shaving devices is a razor shaving apparatus having a handle mechanism with. Such an apparatus would enable a user to extend the reach of a shaving blade of the apparatus significantly beyond the reach of their hands.

### SUMMARY

This present invention approaches the problem of providing extended reach for a user of a razor shaving device by providing the particulars of a unique handle extension assembly.

In accordance with a first aspect of the present invention, there is disclosed a razor handle extension shaving assembly that is easy to use and manufacture having a simplistic, yet efficient design for a handle extension assembly having a substantially unitary structure without relative moving parts.

In accordance with a second aspect of the present invention, there is disclosed a razor handle extension shaving assembly comprised of lightweight materials and containing an array of fluid flow apertures for facilitating use in wet and/or slippery conditions.

In accordance with a third aspect of the present invention, there is disclosed a razor handle extension shaving assembly comprised a unique razor device retention mechanism consisting of a frictional grip means and razor receiving means operatively coupled to one another.

In a further aspect of the invention, there is disclosed a razor handle extension shaving assembly adapted to receive a variety of differently sized razor devices due to the particulars of the razor receiving mechanism components.

In accordance with yet another aspect of the present invention, there is disclosed a razor handle extension shaving assembly providing a unique handle structure having an angled portion along a reduced diameter middle portion.

These and other advantages of the invention will become more apparent after reading the description and claims which follow.

### BRIEF DESCRIPTION OF THE DRAWINGS

Throughout the following views, reference numerals will be used on the drawings, and the same reference numerals will be used throughout the several views and in the description to indicate same or like parts of the invention. Embodiments of the present disclosure are described herein with reference to the drawings, in which:

FIG. 1 is a side elevational view of shaving handle extension apparatus in accordance with an embodiment of the disclosed invention;

FIG. 2 is a top elevational view of the shaving handle extension apparatus, in accordance with an embodiment of the disclosed invention;

FIG. 3 is a bottom elevational view of shaving handle extension apparatus in accordance with an embodiment of the disclosed invention;

FIG. 4 is a front perspective view of the shaving handle extension apparatus in accordance with an embodiment of the disclosed invention; and

FIG. 5A is an exploded elevational perspective of the shaving handle extension apparatus in accordance with an embodiment of the disclosed invention.

FIG. 5B illustrates a reverse, bottom exploded view of FIG. 5A.

### DETAILED DESCRIPTION

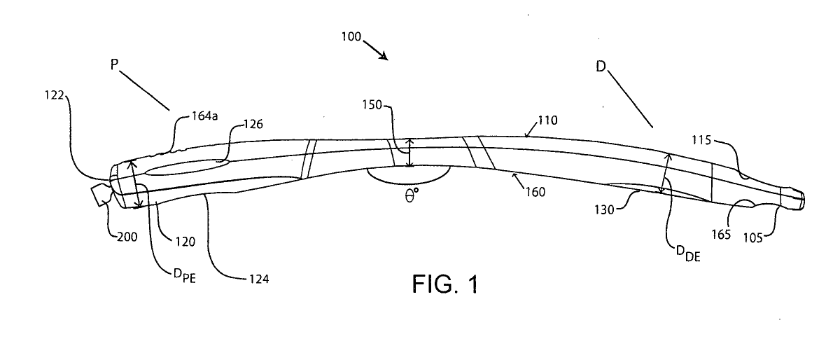

The Shaving Handle Extension Assembly (SHEA) 100 of the present invention is shown in the perspective illustrations of FIGS. 1-5, each showing different views thereof. As it can be seen in the perspective side view of FIG. 1, the SHEA 100 is designed to frictionally receive a Razor Shaving Device (RSD) 200 and subsequently serve as an extending mechanism to manually provide longitudinal extension length to any variety of razor shaving devices 200 for functions associated with hair removal. In this unique extension assembly, an upper handle section 110 and a lower handle section 160 are adjoined together to form a substantially hollow inner chamber for providing a passageway for fluid flow, and for providing a housing for razor gripping receiving means comprising a Razor Receiving Mechanism (RRM) 120 and a Frictional Grip Means 140.

In one embodiment, the SHEA 100 may be sized and dimensioned to have a length in the range of 15 to 18 inches. The body of the SHEA 100 has an angled waist portion 150 which forms the substantially curvilinear shape of the handle extension and is defined by the area by which the minimum width, or narrowed waist portion, of the body of the SHEA 100 is the smallest. This angle, θ is characterized by an obtuse angle having range of approximately 160 to 170 degrees, i.e., 13 to 15 degrees deflection off the horizontal plane. The angled waist portion 150 has a diameter, D_{AWP} of about 0.64 inches, but can range from approximately 0.5 to 0.7 inches, which is concentrically smaller that the diameter of both the proximal end portion P and distal end portion D. Furthermore, the vertex of the obtuse angle lies within the narrowed waist portion of the SHEA 100.

In one embodiment, the diameter of the proximal end portion D_{PE} and the diameter of the distal end portion D_{DE} can range between approximately 1.25 to 2.0 inches, and are both greater than D_{AWP} the diameter of the angled waist portion 150. Furthermore, the diameter of the proximal end portion D_{PE} and the diameter of the distal end portion D_{DE} can be equal to one another, or in some embodiments, they may be unequal. Nonetheless, the diameter D_{AWP} of the angled waist portion 150 has a diameter ratio of about 35-40%, relative to the diameter of the proximal end portion D_{PE} and the diameter of the distal end portion D_{DE}. Therefore, it follows that:

D_{AWP}<D_{PE}

and

D_{AWP}<D_{DE}

This narrowed concentric diameter is critical for facilitating the angled body portion of the SHEA 100.

Furthermore, it also follows that the diameters of each angled waist portions 101, and 161 of the upper handle section 110 and lower handle section 160, respectively, have the same width, therefore 101=161. It is to be understood by those of ordinary skill in the art, that the length of the SHEA 100 may vary in range, however, the proportions of the length of the SHEA 100 to the diameter of the proximal end portion D_{PE} and the diameter of the distal end portion D_{DE} as well as to that of the diameter D_{AWP} of the angled waist portion 150 have relative proportions that define the particular dimensions of the SHEA 100.

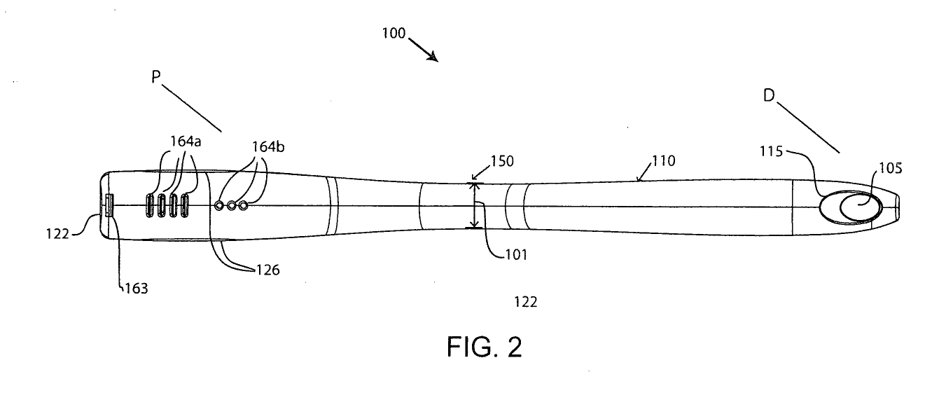

As seen in FIG. 2, the proximal end portion P of the SHEA 100 has a first and second set of fluid apertures 164a and 164b for facilitating fluid flow there through. This is useful when the apparatus is being utilized in conjunction with water sources for aiding in the process for the removal of hair. For instance, when in use, shaving devices are often used along with sources of water for the washing or rinsing of the hair being removed from a target area of the body. This may include baths or shower environments where a shaver may conveniently remove hair during bathing.

The first set of fluid apertures 164a are shown having longitudinally elongated forms and the second set of fluid apertures 164b are shown having more circular formations. The first set of fluid apertures 164a may have larger dimensions than that of the second set of fluid apertures 164a, to provide drainage for larger and/or semi solid materials to exit the inner chamber during usage, such as for example, creams, shaving creams, and the like. It is to be understood by those of ordinary skill in the art that the dimensions, (i.e., shapes) of the apertures 164a and 164b can be of any shape, as the shape is not necessarily critical to the requirement of the function of facilitating fluid flow out of the inner hollow body of the SHEA 100. Furthermore, although they are shown arranged such that the first set 164a are grouped together and separate from the second set 164b, it is to be understood by those of ordinary skill in the art that the relative arrangements and positions thereof can vary without any changes to the scope of the invention.

Since this SHEA 100 may be often used with water and/or other creams, such as shaving creams or hair removal products, handle grip means 130 and razor receiving mechanism 120 are on either ends of the SHEA 100 to provide friction elements for gripping and holding the distal end of the handle body D. In one embodiment 130, handle grip means 130 is located on the distal end portion D of the handle body in a distal aperture 108 and is adapted for frictional grasping of the underside of the SHEA 100. Although this handle grip means 130 is shown as a separate element, it is well within the scope of the invention to manufacture the grip means 130 integrally within the handle body and moreover at more than one location.

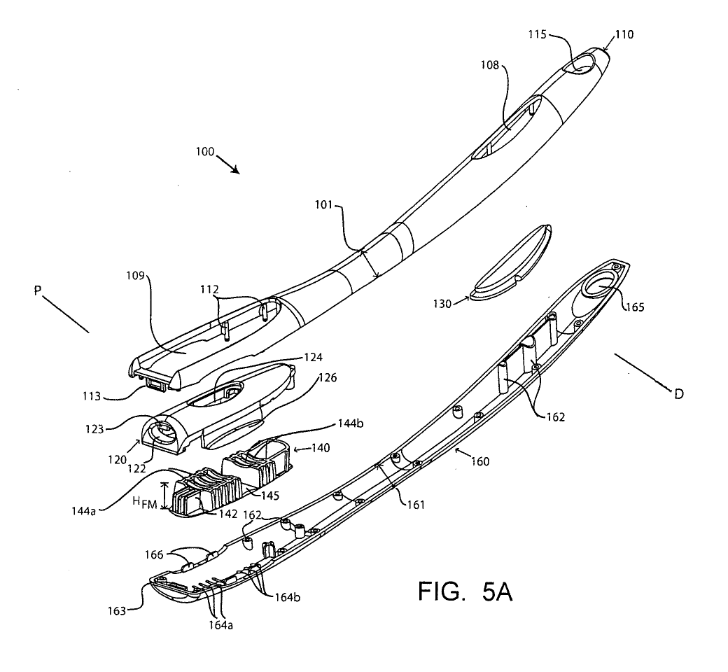

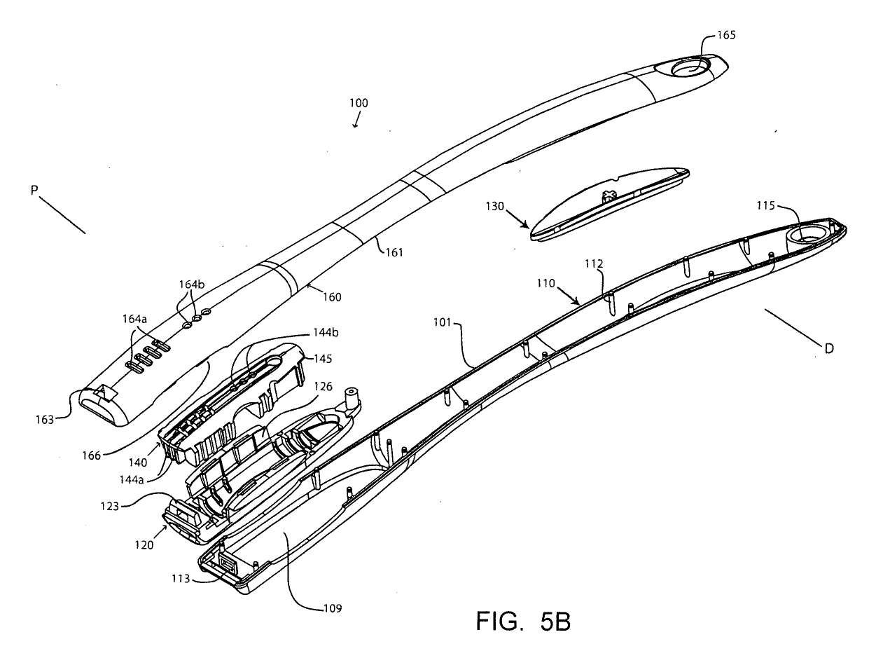

In one embodiment, a placement aperture 105 is formed in the distal end portion D of the SHEA 100 and is used for placing or hanging the assembly 100 for storage when not in use. This placement aperture 105 may be used to place the assembly 100 among hooks, or the like, for hanging and/or storage. The placement aperture 105 is formed by the upper aperture 115 and the lower aperture 165 of the upper and lower handle portions 110 and 160, respectively (note FIGS. 1 and 5).

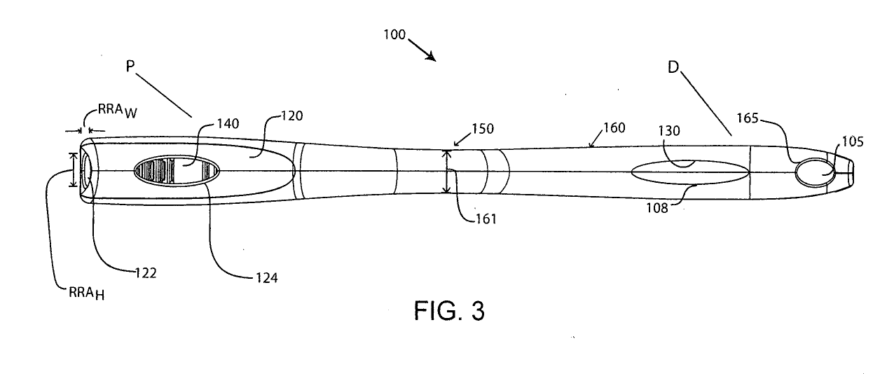

The underside of the SHEA 100 is illustrated in FIG. 3, showing a plan view of the second handle section 160. The frictional grip and receiving means comprising the RRM 120 and the FGM 140 are shown at the proximal end P. The RRM 120 comprises a recessed hole 109 sized and dimensioned to frictionally house a portion of the RRM 120 and FGM 140. This recessed hole 109 lies in a horizontal plane of the upper handle portion 110. The RRM 120 also has a Razor Receiving Aperture (RRA) 122. The RRA 122 is a longitudinal opening for receiving a razor device 200 therein and lies in a vertical plane perpendicular from a lateral opening 124 (discussed below). The RRA 122 has an elliptical form with a height RRA_{H} in the approximate range of about 0.6 to 0.72 inches and a width RRA_{W} in the approximate range of about 0.25 to 0.35 inches, thus an approximate ratio of approximately 42%, RRA_{W} to RRA_{H}.

Moreover, the elliptical form is critical for receiving, and thus, maintaining position of the razor device 200. The compromised height RRA_{H} (in conjunction with the friction fitting of the 120 and 140) is such that it can fit a variety of narrowly dimensioned razor devices 200. The width RRA_{W} is dimensioned to accommodate varying widths of razor devices 200, including those with thin or tapered handle widths. Hence, the elliptical RRA 122 configuration embodies criticality in that the relative ratio of the height to the width being within 40-41%.

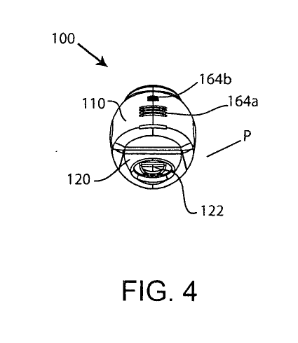

The RRA 122 is sized and dimensioned to operatively receive razor devices having an array of handle sizes. Furthermore, the RRM 120 has a lateral opening 124 serving as a major drainage conduit for fluids. The FGM 140 is operatively connected to the RRA 122, and together form a gripping razor receiving means, both of which are discussed in further detail below with regard to FIGS. 5A and 5B. FIG. 4 illustrates a front perspective view of the SHEA 100, showing the proximal end P.

FIGS. 5A and 5B best illustrates the components that comprise the SHEA 100. In these exploded diagrams, the relationship of the major components to one another can be gleaned. FIG. 5A illustrates a top exploded view of the SHEA 100 and FIG. 5B illustrates a reverse, bottom exploded view of FIG. 5A. In this view the components are shown in an unassembled state, however, when assembled, the upper handle portion 110 and the lower handle portion 160 are adjoined to one another via an array of fastening means 162 and 112. The set of upper handle fastening means 112 are each arranged to matingly engage the set of lower handle fastening means 162.

As illustrated in FIGS. 5A and 5B, the corresponding array of fastening means 112 and 162 are shown in a snap post mechanism, having mating male-female configurations such that upon assembly they are fittingly pressed into one another to mechanically couple the upper and lower handle sections 110 and 160 to one another. It is well known that other, suitable and/or equivalent adjoining means can be employed for augmenting the bond of the fasting means 112 and 162 (such as, for example, including bonding in addition to, or in lieu of a snap post mechanism as illustrated. It is further well known that the adjoining can be a mechanical (e.g., snap posting), chemical bonding (e.g., via any variety of epoxies, bonding solvents, or resins), or via other adjoining means (e.g. material molding of parts) without departing from the scope of the invention.

As can also be seen in further detail in FIGS. 5A and 5B, some of the structural characteristics that provide functionality for the FSM 140 are illustrated. In one embodiment, the FSM 140 comprises a longitudinal base 145 having a plurality raised teeth-like flanges members 142, extending substantially perpendicularly from said base 145. In as much as the height of said flange members 142 may be quantified by H. In addition, H_{FM} is substantially greater than, or equal to the RRA 122 maximum width RRA_{W}. Therefore, it follows that:

H_{FM}≧RRA_{W}.

This particular dimension is of the FSM 140 is such that the height of the flange members 142 substantially occlude the RRA 122 to facilitate a secure, fitted, frictional engagement of a RSD 200.

The plurality of raised flanged members 142 also serve to maintain proper placement of the RSD 200. The snug, friction fitting of this substantially flexible FSM 140 along with the longitudinal arrangement of the flange members 142, exert normal forces on a RSD 200 inserted through RRA 12 between the frictional grip and receiving means of the RRM 120 and FGM 140. The lateral opening 124 may serve to provide a visual access to check the proper placement of a RSD 200. Furthermore, this lateral opening 124 may also be sized and dimensioned to provide access for manual manipulation of an inserted RSD 200 to ensure proper placement before use. Moreover, in any unlikely event that an RSD 200 is lodged improperly or breaks during usage, the lateral opening 124 may serve as a point of access and may be employed to dislodge the RSD 200.

With regard to material considerations, in one embodiment, the upper and lower handle sections 110 and 160 may be comprised of high grade engineered plastics having a higher durometer (e.g., such as Shore D scaled plastics) such as, for example, poly carbonates, and substantially rigid. In one embodiment, the material of both the RRM 120 and FGM 140 are comprised of a softer, more flexible material than the upper and lower handle sections 110 and 160. Both the RRM 120 and FGM 140 may be comprised of any suitable rubber-type material such as, rubbers and/or elastomers commonly used for softer plastics (e.g., such as Shore A scaled elastomers) such as polyolefins, fluoropolymers, and vinyls. These are just exemplary listings, and it is herein noted that other non-plastic materials may be employed as well which may be suitable for manufacture of the SHEA 100.

The RRM 120 also comprises a set of gripping strips 126 on either lateral side thereof which serve the dual purposes of first providing friction handling means for a user of the SHEA 100; and second as a structural engagement means having latch engaging mechanism 128 therein for matingly receiving the latch means 166 of the proximal end P of lower handle section 160 (see FIG. 5B). The latch engaging mechanism 128 is a female receiving structure sized, dimensioned and adapted to receive the latch engaging mechanism 128 which may be correspondingly sized, dimensioned and adapted to provide a male fitting therein.

In the foregoing manner, exemplary embodiments of the present disclosure are described with reference to the figures. Although only exemplary embodiments are of the present disclosure are described, the present invention is not to be limited to specific details so described. The scope of the present disclosure is not limited to the exemplary embodiments of the present disclosure provided above. Numerous changes and modifications can be made to the exemplary embodiments without departing from the scope or spirit of the present invention.

What is claimed is:

1. A handle assembly comprising:
an elongated, curvilinear handle body having a proximal end and a distal end;
said handle body comprised of an obtuse angle;
said handle body having a narrowed waist portion defining a section of minimum width along the handle body;
a razor device retention mechanism housed in the proximal end of the handle body;
and
said handle assembly adapted and configured to extend the length of a razor shaving apparatus.

2. The handle assembly of claim 1,
wherein the narrowed waist portion has a ratio to the width of the handle body of approximately 35-40% of the diameter of the proximal and distal ends.

3. The handle assembly of claim 2,
wherein the vertex of said obtuse angle lies within the narrowed waist portion of said handle body.

4. The handle assembly of claim 3,
wherein the handle body is comprised of an upper handle body portion and a lower handle body portion, said upper and lower handle body portions having adjoining means for adjoining said portions to one another; and
wherein the upper and lower handle body portions are comprised of a material that is substantially rigid.

5. The handle assembly of claim 4,
said assembly having a razor retention mechanism housed between said upper and lower handle body portions; and
wherein said razor retention mechanism is comprised of a material having a softer durometer and being more flexible than said upper and lower handle body portions.

6. The handle assembly of claim 5,
wherein said razor device retention mechanism comprises a friction gripping means and a razor device receiving means.

7. The handle assembly of claim 6,
wherein said friction gripping means is comprised of a body member
having a longitudinal base substantially perpendicular to a plurality of flexible teeth-like frictional flange members extending laterally therefrom in a plane substantially normal to said base.

8. The handle assembly of claim 7,
wherein said upper handle body portion having a proximal aperture where said razor retention mechanism is at least partially contained.

9. The handle assembly of claim 8,
wherein said razor device receiving means has a razor receiving aperture;
said razor receiving aperture located substantially in a vertical plane relative to said proximal aperture.

10. The handle assembly of claim 9,
wherein said distal end of said handle body has a gripping means for providing frictional gripping for a hand of a user; and
wherein said handle body comprises storage means adapted and configured for physically storing said handle assembly when not in use.

11. The handle assembly of claim 10,
wherein said lower handle body portion having a first and second set of fluid flow apertures.

12. The handle assembly of claim 11,
wherein said first set is sized and dimensioned differently from said second set.

13. The handle assembly of claim 5,
wherein said adjoining means comprises a first and second set of fastening means adapted to operatively couple the upper handle portion to said lower handle portion, respectively.

14. The handle assembly of claim 13,
wherein a first set of fastening means comprises a plurality of male fasteners in said upper handle portion; and
wherein a second set of fastening means comprises a plurality of female fasteners in said lower handle portion, and adapted to matingly couple to said male fasteners.

15. The handle assembly of claim 9,
wherein said razor receiving aperture has an elliptical configuration.

16. The handle assembly of claim 8,
wherein said longitudinal base having a set of securing means,
said securing means comprising a set of tab receiving apertures adapted to operatively couple to the tab securing means located along the distal end of said lower handle portion.

17. The handle assembly of claim 15,
wherein said razor receiving aperture having a width in the range of 0.25 to 0.35 inches; and
said razor receiving aperture having a height in the range of 0.6 to 0.72 inches; and
wherein said width to height ratio of the elliptical razor receiving aperture being approximately 42%.

18. The handle assembly of claim 3,
wherein said obtuse angle is in the range of approximately 160-170 degrees.

19. The handle assembly of claim 5,
wherein said upper and lower handle body portions are comprised of a substantially rigid material such as plastics; and
wherein said razor retention mechanism is comprised of a substantially softer material such as elastomers.

20. The handle assembly of claim 7,
said razor device receiving means comprising a set of gripping flange members extending laterally from an upper, longitudinal body; and
said gripping flange members having a height substantially equal to the height of said razor device receiving means.
